(19) United States
(12) Patent Application Publication
(10) Pub. No.: US 2005/0080571 A1
(43) Pub. Date: Apr. 14, 2005

(54) Mass spectrometry performance enhancement

(76) Inventor: Matthew S. Klee, Wilmington, DE (US)

Correspondence Address: AGILENT TECHNOLOGIES, INC.;Legal Department , DL429, Intellectual Property Administration, P.O. Box 7599, Loveland, CO, 80537-0599, US

(21) Appl. No.: 10/682,724

(22) Filed: Oct. 10, 2003

(51) Int. Cl. G06F 19/00

(52) U.S. Cl. 702/32

(57) ABSTRACT

System and method for improving performance in a mass spectrometer by tuning mass spectrometer parameters for each mass across a mass range, fitting the parameters to respective mathematical functions across the mass range, ramping each of the parameters dynamically according to the respective mathematical functions during a mass spectrometer scan, and correcting spectral distortion. To achieve the best signal or signal-to-noise ratio across the mass range of interest, the mass spectrometer parameters are dynamically ramped.

### TECHNICAL FIELD OF THE INVENTION

The present invention relates to mass spectrometry, and more particularly to improvements in performance in mass spectrometry.

### BACKGROUND

Mass spectrometers are known. An illustration of a quadrupole mass spectrometer, a common type of mass spectrometer, is shown in FIG. 1. In one embodiment, a volatile compound, usually from a gas chromatograph, is introduced in a neutral state to the mass spectrometer where it is then ionized in the source, generally designated as reference numeral 105. The compound may be ionized by chemical ionization, by electron impact, or other means depending upon the type of information sought. In the process of ionization, the parent molecule is also fragmented into smaller ions. The degree of ionization and subsequent fragmentation is characteristic of the chemical structure of the parent molecule and is well-dependent on the source design and the control parameters (typically relating to source geometry, temperature, magnetic field, and electric fields such as currents and voltages) associated with the source. In this instance, the ions created in the source are accelerated into a quadrupole mass filter, generally designated by the reference numeral 100, which includes a quadrilaterally symmetric parallel array of four identical rods 110.

In common practice, to obtain a mass spectrum, a DC voltage and superimposed sinusoidally-modulated radio frequency (RF) voltage are applied to the rods of the quadrupole mass filter. The DC voltage and amplitude of the RF voltage are scanned in tandem such that their ratio remains constant. More specifically, each diametrically opposite pair of rods are connected together. A signal, which includes a positive DC component and an RF component, is applied to one pair of rods, while an opposite, which includes a negative DC component and an RF component opposite in phase to the RF component of the first mentioned signal, is applied to other pair of rods. The DC and RF component signals are scanned such that their ratio of amplitudes is kept constant. During the scan, the DC and RF component signals are stepped in discrete amounts and signal measurements are made until the mass range of interested has been covered. The flux of ions exiting the source and entering the mass filter is partitioned and exits the quadrupole mass filter according to the mass-to-charge ratio (m/e) of each ion. By scanning the DC voltage and RF amplitude components from a high to a low value (or low to high) in discrete steps, a plurality of ions, each having a particular mass-to-charge ratio and arriving simultaneously at the entrance to the quadrupole mass filter, will arrive sequentially and ordered according to its particular mass-to-charge ratio at the exit of the quadrupole mass filter. By scanning the DC voltage and RF amplitude in a coordinated fashion from a high to a low value, ions having a relatively high mass-to-charge ratio will arrive at the end of the quadrupole mass filter before ions having a relatively low mass-to-charge ratio. In the case of scanning DC voltage and RF amplitude from low to high, ions having a smaller mass-to-charge ratio will come out before ions having a higher mass-to-charge ratio. The ion flux exiting the mass analyzer is sensed by a detector, such as a Faraday cup 130.

The acquired data array of signal intensity versus mass-to-charge is called a mass spectrum. Mass spectra are characteristic of the parent molecule and the conditions under which the spectra were collected. Providing that reproducible conditions are used for collecting spectra they thereby represent effective fingerprints of the parent compounds. A common way of identifying unknowns in a sample is to compare the mass spectra of the components in the sample to spectra in a reference library of known data 190. There exist large libraries that include many decades' worth of identified compounds, mostly using old mass spectrometers of a certain ion formation, separation, and detection paradigm.

The traditional approach to tuning mass spectrometers is to reach to a median setting that corresponds to a compromise in specific target of performance, e.g., signal intensity, over the mass range of the instrument. In this approach, many of the electronic parameters associated with operating quadrupole mass spectrometers are static during the scanning process. This emanates from the original paradigm of mass spectrometry where these parameters were adjusted with manually controlled devices. This paradigm of tuning mass spectrometer performance to a compromise setting with static electronic parameters has to a great degree been adopted by and maintained in typical quadrapole mass spectrometers.

Compromise values are determined through an automated (e.g., tune 150) or manual process that currently focuses on maximum signal. Since there are mass-dependent optima for each parameter, a compromise value is set based on a simple or weighted average of values associated with the maximum response in a preset range. Each parameter or value is chosen based on the optimum at only one point in the mass range.

The nature of ion formation, collection, and separation, as well as the characteristics of electronic and digital responses in a given mass spectrometer design, however, combine to create different optimal values of parameters across the mass range. In other words, maximum performance (e.g., signal, signal-to-noise, resolution, dynamic range, etc.) for low mass ions requires different setpoints than that for mid- and high-mass ions. Today, the conventional “tuning” process yields static values that are generally acceptable across the mass range of interest, but which fail to yield the best performance across the mass range.

Currently, new mass spectrometer designs have the potential to collect mass spectra under a different paradigm than older instruments, and can be optimized to yield improvements in performance relative to prior designs and static control approaches. These improvements are very much tied to a combination in improvements in electronics, mechanical and electrical design, and a long period of practical experience. For instance, improvements in electronics technology have allowed replacement of tumpots and manual controls of older instruments with computer controlled electronics. With these improvements in design and control has come the possibility of ramping parameters that were heretofore static, and of maximizing the performance of mass spectrometers across the range of use of the instrument.

### SUMMARY

The present invention is directed to a system and method for improving performance in a mass spectrometer by tuning mass spectrometer parameters for each mass across a mass range, fitting the parameters to respective mathematical functions across the mass range, ramping each of the parameters dynamically according to the respective mathematical functions during a mass spectrometer scan, and correcting spectral distortion. To achieve the best performance (e.g., signal, signal-to-noise ratio, resolution, dynamic range, etc.) across the mass range of interest, the mass spectrometer parameters are dynamically ramped.

### DESCRIPTION OF THE DRAWINGS:

The features, aspects, and advantages of the present invention will become better understood with regard to the following description, appended claims, and accompanying drawings where:

FIG. 1 depicts a known mass spectrometer;

FIG. 2 depicts a mass spectrometer according to an embodiment of the present invention;

FIG. 3 depicts a flowchart showing the operation of an embodiment of the present invention;

FIG. 4 depicts a graph showing the dependence on repeller voltage of signal;

FIG. 5 depicts a graph showing the relationship between repeller voltage corresponding to maximum signal and mass-to-charge ratio;

FIG. 6 depicts a graph showing the dependence of signal on emission current; and

FIG. 7 depicts a graph showing the relationship between repeller voltage and emission current at multiple mass-to-charge ratios.

### DETAILED DESCRIPTION

The present invention is a system and methodology utilized to improve the capabilities of a mass spectrometer. Mass spectrometers use a variety of control parameters including emission current, electron energy, repeller voltage, ion focus voltage, mass axis offset, mass axis gain, amu (atomic mass unit) offset, amu gain, entrance lens voltage, electron multiplier voltage, and entrance lens offset. For purposes of illustration, the present invention is described herein in connection with quadrupole mass spectrometers, although the present invention can also be used in connection with other types of mass spectrometers (e.g., ion trap, magnetic sector, time-of-flight, etc.).

The present invention is not restricted to a specific optimization goal across the mass range of interest. In the current paradigm, signal intensity is chosen, from which a compromise value is determined for the mass range of interest. It is of more interest to most analysts to maximum performance in terms of an analytical figure of merit such as signal-to-noise ratio. Other figures of merit include sensitivity, dynamic range, linear dynamic range, repeatability, precision, accuracy, stability, ruggedness, bias, selectivity, resolution, etc.

For purposes of illustration, the present invention is described with a focus on maximizing signal. However, it should be understood that the present invention encompasses optimizing all figures of merit. The means of controlling the mass spectrometer to optimize any one of these figures of merit may in turn degrade another, so optimizing the performance of the mass spectrometer must be tied to the analytical goals. For example, high resolution analyses will most likely degrade detection limit, reproducibility, and dynamic range. Optimal ruggedness, for example, rarely occurs when the mass spectrometer is optimized to give the highest performance in terms of sensitivity and resolution.

A set of mass spectrometry (MS) parameters associated with maximum S/N is often not the same as one for maximum signal. In one embodiment, conditions for maximum performance would be determined across the mass range of interest, as measured by appropriate analytical figures of merit (quality metrics).

Many of the control parameters benefiting from dynamic ramping are associated with the source. These parameters include emission current (e.g., filament current, flux of ionizing radiation such as light or electrons), electron energy (e.g., ionization voltage, ionization energy, photon energy, electrical field strength), magnetic field (e.g., strength, direction, distortion), repeller voltage (i.e., the lens deflecting ions toward the mass analyzer), lens voltages (i.e., any number of lenses used for collecting, focusing, and moving ions to the entrance of the mass analyzer), temperature, pressure, and field ionization target potential. Other control parameters of the particular mass spectrometer, in this case a quadrupole mass spectrometer, which may be ramped, include the parameters with peak width and mass assignment. They have associated gain and offset values, indicating a linear ramp function associated with mass axis scanning. Linear ramping does not necessarily correspond to the best function to describe the change necessary to maintain optimal results across the mass range. Even the current ramps that are employed might not be of optimal form.

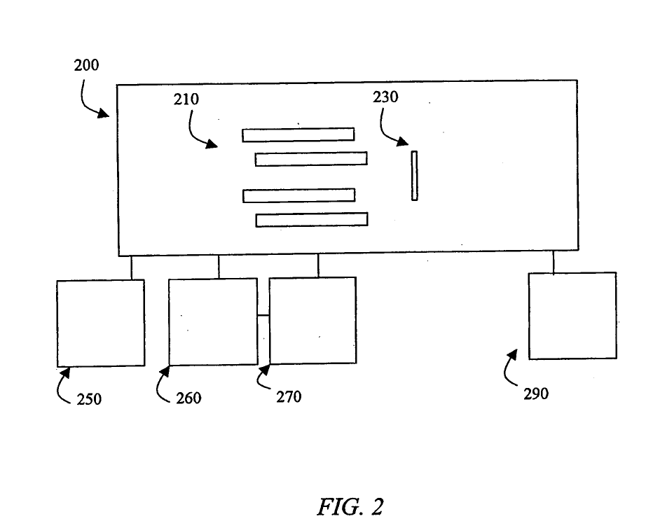

With respect now to FIG. 2, there is shown a mass spectrometer according to an aspect of the present invention. The mass spectrometer is generally designated by the reference numeral 200, and will be described in more detail below.

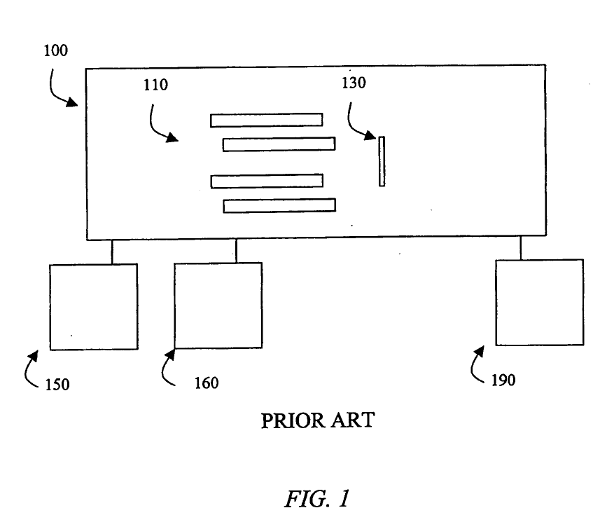

As described with reference to the mass spectrometer 100 of FIG. 1, the mass spectrometer 200 of FIG. 2 has a source 205 where ions are formed, focused and directed to the mass filter, four rods 210 through which ions are filtered/separated based on m/e, and a detector 230, which may be a Faraday cup, that receives the ions. The mass spectrometer 200 is controlled by various control parameters, as noted hereinabove, such as emission current, electron energy, magnetic field, repeller voltage, lens voltages, temperature, pressure, field ionization target potential, mass axis offset, mass axis gain, amu (atomic mass unit) offset, and amu gain.

The mass spectrometer 200 is optimized by an optimizing tune process 250, which is more sophisticated than the tune process 150 of the mass spectrometer 100. The optimization process 250 will optimize the spectrometer 200 for optimal performance across the mass range of interest, according to a chosen performance metric. Possible performance metrics, as noted hereinabove, include maximum signal-to-noise ratio, minimum noise, mass range, peak width, sensitivity, dynamic range, linear dynamic range, repeatability, precision, accuracy, stability, ruggedness, bias, selectivity, and resolution.

When the mass spectrometer 200 is optimized, the necessary MS control parameters will be dynamically ramped during each scan by the scan control 270. Because the mass spectrometer takes measurements during scan, the dynamic ramping of the particular control parameters occurs in a discrete, stepwise fashion, and the optimal mass spectrometer parameters are determined and applied as a function of mass-to-charge. The control parameters are ramped in order to optimize performance of the mass spectrometer 200 to a particular performance parameter, according to a mathematical function, derived by the tune process 250. The scan control 270 may be located in the mass spectrometer 200, or may be separate.

As in the mass spectrometer 100, the results of the mass spectrometer 200 may be compared to a reference library 290, which contains a large reference of known compounds.

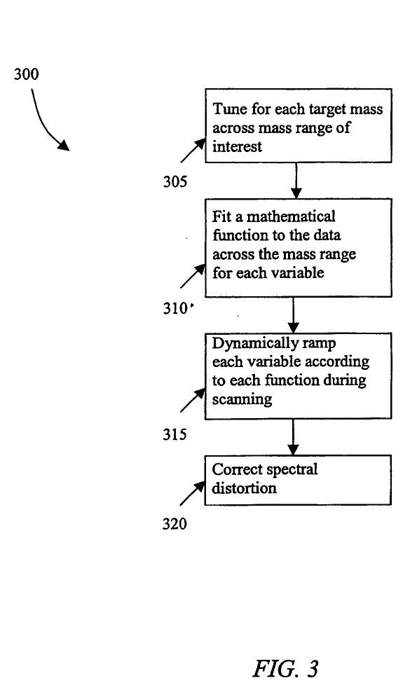

With reference now to FIG. 3 of the Drawings, there is shown therein a flowchart, depicting a method of performing the present invention. The process is generally designated by the reference numeral 300, and will be described in detail below.

Initially, the mass spectrometer is tuned for each particular mass across the entire mass range of interest (step 305). The tuning is determined by a systematic adjustment of variables to yield optimum performance as measured by metrics of interest, e.g., signal-to-noise ratio, signal intensity, or noise level, at representative masses across the mass range of interest.

Then, a mathematical function is fitted to the data spanning the entire mass range for each MS control parameter (step 310). Some variations will lend themselves to linear functions, others non-linear functions, and yet others may have little effect on the specific performance attribute of interest (a single, static value will suffice).

Next, each variable will be controlled during scanning according to the resulting relationships (step 315). In one example, at least one source parameter would be independently, dynamically ramped, while the others would be statically controlled. In another example, all MS control variables in the source, mass filter, and detector would change in a dependent fashion during spectra acquisition.

Finally, any spectral distortion will be corrected (see concurrently filed U.S. patent application Ser. No. xx/xxx,xxx entitled “Spectral Correction”) (step 320).

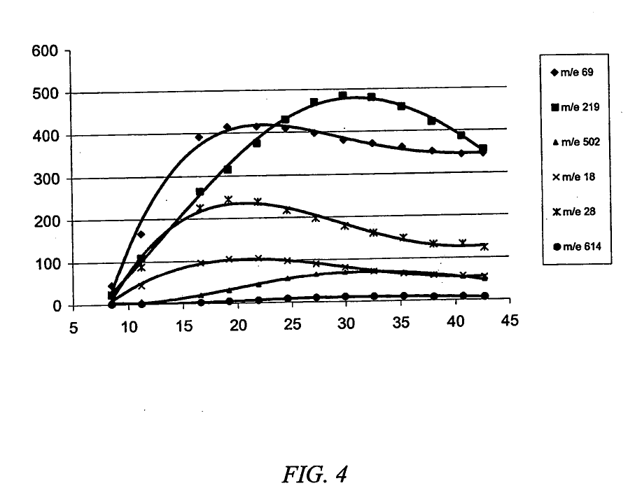

With respect now to FIG. 4, there is shown therein a graph of an example of the dependence of response on a particular MS control parameter. In FIG. 4, there is shown the dependence of response on repeller voltage for several different masses. The graph of FIG. 4 shows repeller voltage in volts on the x-axis and abundance on the y-axis. Each different curve shows a different mass-to-charge ratio, and each curve has a different maximum. As the graph shows, using a single repeller voltage would not maximize the signal for all ions.

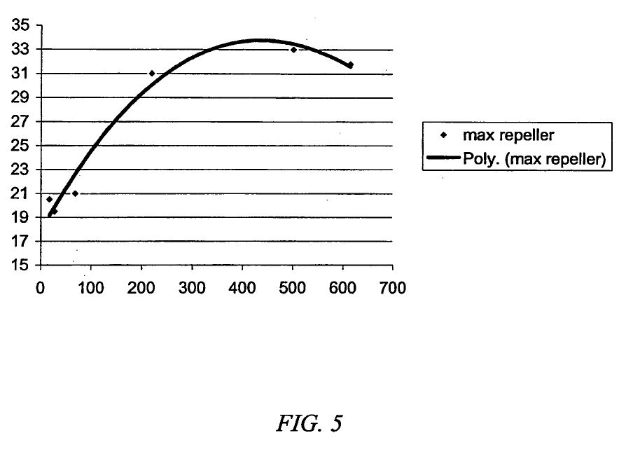

The trend in repeller voltage corresponding to maximum signal across the mass range of the mass spectrometer is shown in FIG. 5. The graph of FIG. 5 shows mass-to-charge ratios on the x-axis and repeller voltage (in volts) for maximum signal on the y-axis. As the graph shows, maximum signal across the mass range could be achieved by ramping the repeller voltage dynamically during each scan.

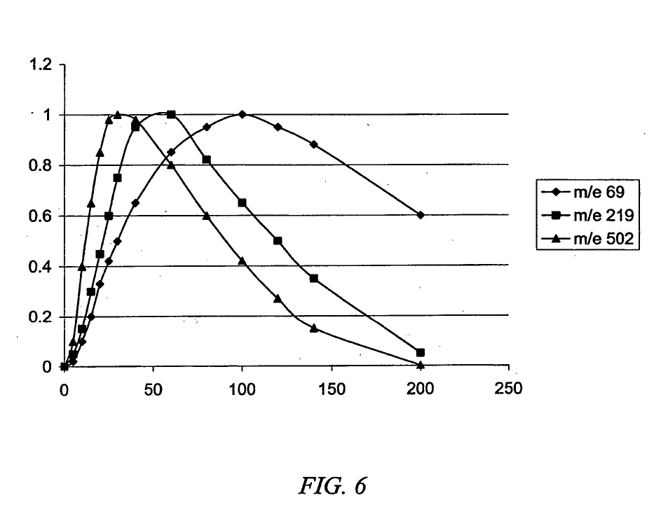

With respect now to FIG. 6, there is shown further the relationship of a control parameter upon response. In FIG. 6, there is shown the dependence of response on emission current for several different masses. The graph of FIG. 6 shows emission current in uA on the x-axis and relative response on the y-axis. Each different curve shows a different mass-to-charge ratio, and each curve has a different maximum. As the graph shows, using a single emission current would not maximize the signal for all ions and across all mass ranges.

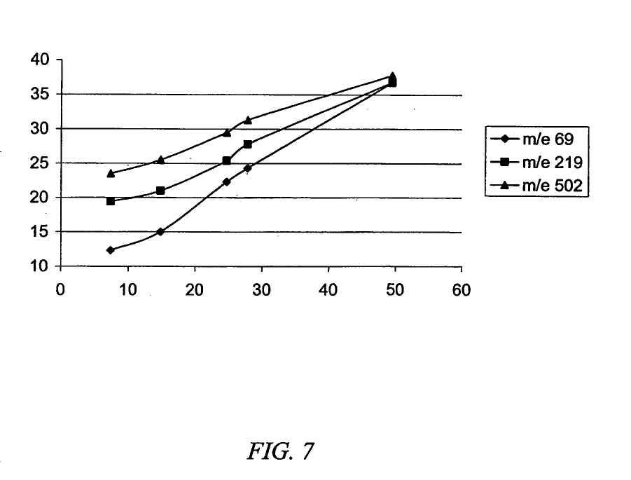

The trend in emission current and repeller voltage at maximum signal is shown in FIG. 7. The graph of FIG. 7 shows multiple mass-to-charge ratios with emission current in uA on the x-axis and repeller voltage (in volts) for maximum signal on the y-axis. As the graph shows, maximum signal across the mass range could be achieved by ramping the repeller voltage dynamically during each scan.

As FIGS. 4 to 7 show, dynamically ramping one control variable will increase signal response, and ramping an additional control variable will further increase signal response. The magnitude of the effect on signal response is a complex function of many things, including, but not restricted to, the specific mechanical and electrical designs of the source, mass filter and detector, and experimental variables such as source pressure and temperature, and type and concentration of any chemicals present (intentional or otherwise).

A similar process can be followed for each of the operational variables of the mass spectrometer. Also, a similar process can be followed to optimize performance based on the interaction between variables, as changes in one variable often influences optimal settings of others.

The ability to dynamically ramp parameters for optimal performance has two applications: during each scan or associated with each mass when running in selected ion monitoring mode, and during the length of the chromatographic run during which some portions of the analysis may require high resolution, for example. In the latter case, each section would have different sets of optimal parameters according to its requirements, and the appropriate set of parameters would be used for each section of the chromatographic run.

The foregoing description of the present invention provides illustration and description, but is not intended to be exhaustive or to limit the invention to the precise one disclosed. Modifications and variations are possible consistent with the above teachings or may be acquired from practice of the invention. Thus, it is noted that the scope of the invention is defined by the claims and their equivalents.

1. A method for improving performance in a mass spectrometer, said method comprising:
tuning at least one mass spectrometer parameter across a mass range;
fitting said at least one mass spectrometer parameter to a mathematical function across said mass range; and
ramping said at least one mass spectrometer parameter dynamically according to said mathematical function during a mass spectrometer scan.

2. The method according to claim 1, wherein said mass spectrometer is a quadrupole mass spectrometer.

3. The method according to claim 1, wherein said mass spectrometer parameter is selected from the group consisting of emission current, electron energy, magnetic field, repeller voltage, lens voltages, temperature, pressure, field ionization target potential, mass axis offset, mass axis gain, atomic mass unit offset, and atomic mass unit gain.

4. The method according to claim 1, wherein said mathematical function is linear.

5. The method according to claim 1, wherein said mathematical function is non-linear.

6. The method according to claim 1, wherein said mass spectrometer parameter is tuned to optimize a mass spectrometer performance attribute.

7. The method according to claim 6, wherein said performance attribute is selected from the group consisting of maximum signal-to-noise ratio, minimum noise, sensitivity, dynamic range, linear dynamic range, repeatability, precision, accuracy, stability, ruggedness, bias, selectivity, and resolution.

8. The method according to claim 1, wherein one mass spectrometer parameter is ramped during scan while the remaining mass spectrometer parameters are static.

9. The method according to claim 1, wherein two or more mass spectrometer parameters are ramped during scan while the remaining mass spectrometer parameters are static.

10. The method according to claim 1, wherein all mass spectrometer parameters are ramped during scan.

11. A mass spectrometer comprising:
means for measuring a mass-to-charge ratio of an ion;
means for optimizing a mass spectrometer performance metric for multiple masses in a mass range; and
means for dynamically ramping control parameters as a function of mass-to-charge ratio.

12. The mass spectrometer according to claim 11, wherein said control parameters are selected from the group consisting of emission current, electron energy, magnetic field, repeller voltage, lens voltages, temperature, pressure, field ionization target potential, mass axis offset, mass axis gain, atomic mass unit offset, and atomic mass unit gain.

13. The mass spectrometer according to claim 11, wherein said performance metric is selected from the group consisting of maximum signal-to-noise ratio, minimum noise, sensitivity, dynamic range, linear dynamic range, repeatability, precision, accuracy, stability, ruggedness, bias, selectivity, and resolution.

14. A mass spectrometer comprising:
an ion generator;
a mass filter;
a mass detector;
and a tuning control device, said tuning control device dynamically ramping at least one control parameter during scan, thereby optimizing a performance metric.

15. The mass spectrometer according to claim 14, wherein said mass spectrometer is a quadrupole mass spectrometer.

16. The mass spectrometer according to claim 14, wherein said at least one control parameter is selected from the group consisting of emission current, electron energy, magnetic field, repeller voltage, lens voltages, temperature, pressure, field ionization target potential, mass axis offset, mass axis gain, atomic mass unit offset, and atomic mass unit gain.

17. The mass spectrometer according to claim 14, wherein said performance metric is selected from the group consisting of maximum signal-to-noise ratio, minimum noise, sensitivity, dynamic range, linear dynamic range, repeatability, precision, accuracy, stability, ruggedness, bias, selectivity, and resolution.

18. The mass spectrometer according to claim 14, wherein one control parameter is ramped during scan while the remaining control parameters are static.

19. The mass spectrometer according to claim 14, wherein two or more control parameters are ramped during scan while the remaining control parameters are static.

20. The mass spectrometer according to claim 14, wherein all control parameters are ramped during scan.
